(19) United States
(12) Patent Application Publication
(10) Pub. No.: US 2025/0149246 A1
(43) Pub. Date: May 8, 2025

(54) CAPACITOR

(71) Applicant: DENSO CORPORATION, Kariya-city (JP)

(72) Inventors: Seido ARAKI, Kariya-city (JP); Hidenori Echizen, Kariya-city (JP); Hiroshi Kato, Kariya-city (JP)

(73) Assignee: DENSO CORPORATION, Kariya-city (JP)

(21) Appl. No.: 19/011,780

(22) Filed: Jan. 7, 2025

Related U.S. Application Data
(63) Continuation of application No. PCT/JP2023/029053, filed on Aug. 9, 2023.

(30) Foreign Application Priority Data
Aug. 25, 2022 (JP) 2022-134419

(51) Int. Cl. H01G 4/224; H01G 4/236; H01G 4/32; H01G 13/00

(52) U.S. Cl. CPC H01G 4/224; H01G 4/236; H01G 4/32; H01G 13/003; H01G 13/006

(57) ABSTRACT

A capacitor includes a capacitor element, an outer shell member, and a film. The capacitor element includes a first end surface having a first electrode, a second end surface having a second electrode and a side surface extending between the first end surface and the second end surface. The outer shell member is provided on the first end surface and the second end surface and suppresses a permeation of moisture. The film overlaps with the outer shell member and covers the side surface, is lighter in weight per unit area than the outer shell member, and works together with the outer shell member to suppress the permeation of moisture into the capacitor element.

### CROSS REFERENCE TO RELATED APPLICATIONS

The present application is a continuation application of International Patent Application No. PCT/JP2023/029053 filed on Aug. 9, 2023, which designated the U.S. and claims the benefit of priority from Japanese Patent Application No. 2022-134419 filed in Japan filed on Aug. 25, 2022, the entire disclosure of the above application is incorporated herein by reference.

### TECHNICAL FIELD

The disclosure provided herein relates to a capacitor.

### BACKGROUND

A case mold type capacitor includes a capacitor element, a resin case for accommodating the capacitor element, and a filling resin that fills the case.

### SUMMARY

It is an object of the present disclosure to provide a capacitor that has reduced weight and improved protection of the capacitor element from moisture.

A capacitor according to one aspect of the present disclosure includes:
a capacitor element having a first end surface having a first electrode, a second end surface having a second electrode, and a side surface extending between the first end surface and the second end surface,
an outer shell member provided on the first end surface and the second end surface, the outer shell member suppressing a permeation of moisture, and
a film that overlaps with the outer shell member and covers the side surface, is lighter in weight per unit area than the outer shell member, and works together with the outer shell member to suppress the permeation of moisture into the capacitor element.

### BRIEF DESCRIPTION OF THE DRAWINGS

FIG. 1 is a perspective view of a capacitor;

FIG. 2 is a cross-sectional view taken along line II-II shown in FIG. 1;

FIG. 3 is a side view of the capacitor;

FIG. 4 is a flowchart illustrating a method for manufacturing the capacitor;

FIG. 5 is a cross-sectional views illustrating a method for manufacturing the capacitor;

FIG. 6 is a side view illustrating a method for manufacturing the capacitor;

FIG. 7 is a perspective view of a capacitor according to a second embodiment;

FIG. 8 is a cross-sectional view taken along line VIII-VIII of FIG. 7;

FIG. 9 is a perspective view of the capacitor according to a third embodiment;

FIG. 10 is a cross-sectional view taken along a line X-X in FIG. 9;

FIG. 11 is a cross-sectional view of the capacitor according to a fourth embodiment;

FIG. 12 is a perspective view of the capacitor according to a fifth embodiment;

FIG. 13 is a cross-sectional view taken along line XIII-XIII shown in FIG. 12;

FIG. 14 is a cross-sectional view of a capacitor according to a sixth embodiment;

FIG. 15 is a cross-sectional view of a capacitor according to a seventh embodiment;

FIG. 16 is a cross-sectional view of a capacitor according to an eighth embodiment;

FIG. 17 is a cross-sectional view of a capacitor according to a ninth embodiment; and

FIG. 18 is a cross-sectional view of a capacitor according to a tenth embodiment.

### DETAILED DESCRIPTION

In an assumable example, a case mold type capacitor includes a capacitor element, a resin case for accommodating the capacitor element, and a filling resin that fills the case.

An exterior of the capacitor must be lightweight and have the ability to protect the capacitor element from moisture. From this perspective, further improvements in the capacitor are required.

It is an object of the present disclosure to provide a capacitor that has reduced weight and improved protection of the capacitor element from moisture.

A capacitor according to one aspect of the present disclosure includes:
a capacitor element having a first end surface having a first electrode, a second end surface having a second electrode, and a side surface extending between the first end surface and the second end surface,
an outer shell member provided on the first end surface and the second end surface, the outer shell member suppressing a permeation of moisture, and
a film that overlaps with the outer shell member and covers the side surface, is lighter in weight per unit area than the outer shell member, and works together with the outer shell member to suppress the permeation of moisture into the capacitor element.

It is possible to provide a capacitor that is lighter in weight and has improved performance in protecting the capacitor element from moisture.

The following will describe embodiments for carrying out the present disclosure with reference to the drawings. In each of the embodiments, the same reference numerals are assigned to portions corresponding to the items described in the preceding embodiments, and a repetitive description of the corresponding portions may be omitted. When only a part of the configuration is described in each embodiment, another embodiment described previously may be applied to the other parts of the configuration.

It may be possible not only to combine parts the combination of which is explicitly described in an embodiment, but also to combine parts of respective embodiments the combination of which is not explicitly described if any obstacle does not especially occur in combining the parts of the respective embodiments.

### First Embodiment

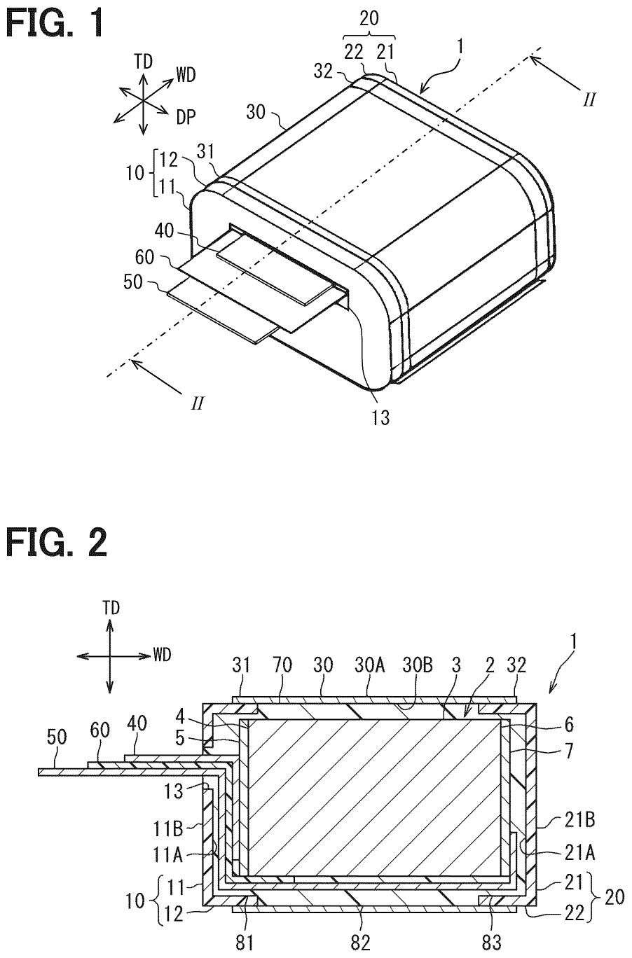

A capacitor 1 according to a first embodiment will be described with reference to FIG. 1. FIG. 2 shows a cross section of the capacitor 1 in the direction of an arrow II in FIG. 1. The capacitor 1 includes a capacitor element 2, a first outer shell member 10, a second outer shell member 20, a film 30, a first conductive member 40, a second conductive member 50, an insulating member 60, and a resin member 70.

In describing each component, a short side direction of the film 30 and an axial direction extending between the end surfaces on which the electrodes described below are arranged may be referred to as a width direction WD for convenience. A depth direction perpendicular to the width direction WD may be referred to as a depth direction DP. A thickness direction perpendicular to the width direction WD and the depth direction DP may be referred to as a thickness direction TD. Further, a direction perpendicular to an axis along the width direction WD may be referred to as a radial direction.

The capacitor element 2 is a film capacitor. A film capacitor is formed by providing a dielectric film with vapor-deposited metal electrodes, and winding the dielectric film so that the vapor-deposited metal electrodes face each other. Metallicon electrodes are formed on both end surfaces of the film capacitor by spraying metal. A vapor-deposited metal electrode of one polarity is electrically connected to one of the metallikon electrodes. A vapor-deposited metal electrode of the other polarity is electrically connected to the other metallikon electrode.

The capacitor element 2 has a three-dimensional shape with a certain volume. The capacitor element 2 may be provided in a three-dimensional shape such as a cylinder, an elliptical cylinder, a polygonal prism, a cube, or a rectangular parallelepiped. The capacitor element 2 has at least two end surfaces 4, 6 and a side surface 3. One end surface of the capacitor element 2 in width direction WD is referred to as a first end surface 4. The metallikon electrode provided on the first end surface 4 is referred to as a first electrode 5. The other end surface of capacitor element 2 in width direction WD is referred to as a second end surface 6. The metallikon electrode provided on the second end surface 6 is referred to as a second electrode 7. The first electrode 5 and the second electrode 7 are provided apart from each other in the width direction WD. The side surface 3 connects the first end surface 4 and the second end surface 5. The side surface 3 extends along the edges of the first end surface 4 and the second end surface 6. The side surface 3 extends circumferentially along the edges of the first end surface 4 and the second end surface 6 about an axis along the width direction WD.

The first outer shell member 10 is a cylindrical cap with a bottom provided on the first end surface 4. The first outer shell member 10 is made of an insulating material such as resin. The first outer shell member 10 has a first bottom portion 11 and a first side portion 12. The first bottom portion 11 has a first inner surface 11A facing the first electrode 5 and a first outer surface 11B on the rear side thereof. The first bottom portion 11 and the first side portion 12 are continuous and made of the same material. The first side portion 12 extends annularly along a periphery of the first bottom portion 11. The first bottom portion 11 also has a first exposure hole 13 that opens to the first inner surface 11A and the first outer surface 11B. The first exposure hole 13 is a hole for exposing the first conductive member 40, the second conductive member 50, and the insulating member 60.

The second outer shell member 20 is a cylindrical cap with a bottom provided on the second end surface 6. The second outer shell member 20 is made of an insulating material such as resin. The second outer shell member 20 includes a second bottom portion 21 and a second side portion 22. The second bottom portion 21 has a second inner surface 21A facing the second electrode 7 and a second outer surface 21B on the rear side thereof. The second bottom portion 21 and the second side portion 22 are continuous and made of the same material. The second side portion 22 extends annularly along the periphery of the second bottom portion 21. Hereinafter, the first outer shell member 10 and the second outer shell member 20 may not be distinguished from each other and may be simply referred to as outer shell members 10 and 20, as appropriate.

The film 30 has a flat shape having a thickness between a front surface 30A and a rear surface 30B. The film 30 has an integrated structure in which a front resin layer, a metal layer, and a rear resin layer are laminated. The front surface 30A corresponds to the front resin layer. The rear surface 30B corresponds to the rear resin layer. For example, polypropylene, nylon, or the like is used for the resin layer. As an example, aluminum is used for the metal layer.

The front resin layer, the metal layer, and the rear resin layer each have a thickness of several tens of micrometers. The film 30 has a thickness of several hundred micrometers. The outer shell members 10, 20 have a thickness of several millimeters. The weight per unit area of the film 30 is lighter than the weight per unit area of the outer shell members 10, 20. Film 30, together with outer shell members 10, 20, plays a role in protecting the capacitor element 2 from external moisture. The film 30 and outer shell members 10, 20 provide the necessary low moisture permeability. The film 30 has the property of being less permeable to moisture than the outer shell members 10, 20. The moisture permeability of the film 30 is lower than the moisture permeability of the outer shell members 10, 20.

The film 30 has two ends in its short direction. The film 30 has two ends in its longitudinal direction. Hereinafter, one of the ends of the film 30 in its short direction may be referred to as a first film end 31. Another one of the ends of the membrane 30 in its short direction may be referred to as a second film end 32. One of the ends of the film 30 in its longitudinal direction may be referred to as a third film end 33. Another one of the ends of the film 30 in its longitudinal direction may be referred to as a fourth film end 34. The film ends 31 to 34 each include a region having a width on the end side. At the end surface of the first film end 31 and the end surface of the second film end 32, the first layer, the second layer, and the third layer are exposed to the outside. At the end surface of the third film end 33 and the end surface of the fourth film end 34, the first layer, the second layer, and the third layer are exposed to the outside.

The first conductive member 40 is a conductive bus bar. The first conductive member 40 is electrically and mechanically connected to the first electrode 5. As an example, the end of the first conductive member 40 and the first electrode 5 are joined by welding. The second conductive member 50 is a conductive bus bar. The second conductive member 50 is electrically and mechanically connected to the second electrode 7. As an example, the end of the second conductive member 50 and the second electrode 7 are joined by welding. Hereinafter, the first conductive member 40 and the second conductive member 50 may not be distinguished from each other and may be referred to simply as the conductive members 40 and 50.

The insulating member 60 is a member provided between the first conductive member 40 and the second conductive member 50. The insulating member 60 prevents the first conductive member 40 and the second conductive member 50 from being electrically conductive. The resin member 70 is made of a component such as epoxy resin or urethane resin. The resin member 70 has a property of being hardenable at room temperature. The capacitor element 2 is fixed to the first outer shell member 10, the second outer shell member 20, and the film 30 by the resin member 70. The resin member 70 may have a property of being hardenable by heat.

An end of the first conductive member 40 is electrically and mechanically connected to the first electrode 5. The first conductive member 40 has a portion extending along the first end surface 4 and a portion extending in the width direction WD so as to move away from the first end surface 4. An end of the second conductive member 50 is electrically and mechanically connected to the second electrode 7. The second conductive member 50 has a portion extending along the second end surface 6, the side surface 3, and the first end surface 4, and a portion extending in the width direction WD away from the first end surface 4. The insulating member 60 is provided between the first conductive member 40 and the second conductive member 50. The insulating member 60 has a portion extending along the side surface 3 and the first end surface 4, and a portion extending in the width direction WD so as to move away from the first end surface 4.

The first outer shell member 10 is provided on the first end surface 4 In a state in which the first conductive member 40, the second conductive member 50, and the insulating member 60 are exposed from the first exposure hole 13. In the width direction WD, the first bottom portion 11 overlaps with the first electrode 5. In the width direction WD, a portion of the first conductive member 40, a portion of the second conductive member 50, and a portion of the insulating member 60 are provided within the projected area of the first bottom portion 11. In the radial direction, the first side portion 12 overlaps a portion of the side surface 3. In the radial direction, a portion of the first conductive member 40, a portion of the second conductive member 50, and a portion of the insulating member 60 are provided within the projected area of the first side portion 12.

The second outer shell member 20 is provided on the second end surface 6. In the width direction WD, the second bottom portion 21 overlaps with the second electrode 7. In the width direction WD, a portion of the second conductive member 50 is provided within the projected area of the second bottom portion 21. In the radial direction, the second side portion 22 overlaps a portion of the side surface 3. In the radial direction, a portion of the second conductive member 50 is provided within the projection area of the second side portion 22.

The film 30 is provided on the outer periphery of the capacitor element 2 so that its longitudinal direction is aligned with the longitudinal direction of the side surface 3. The film 30 covers the side surface 3. Furthermore, in the radial direction, the film 30 is disposed farther away from the capacitor element 2 than the outer shell members 10, 20. The first film end 31 and the second film end 32 each have a region including a width in the short side direction. The first film end 31 overlaps the first side portion 12 in a layered manner in the radial direction. The second film end 32 overlaps the second side portion 22 in a layered manner in the radial direction. The film 30 may extend to the bottom portions 11, 21 and overlap the bottom portions 11, 21 in a layered manner in the width direction WD.

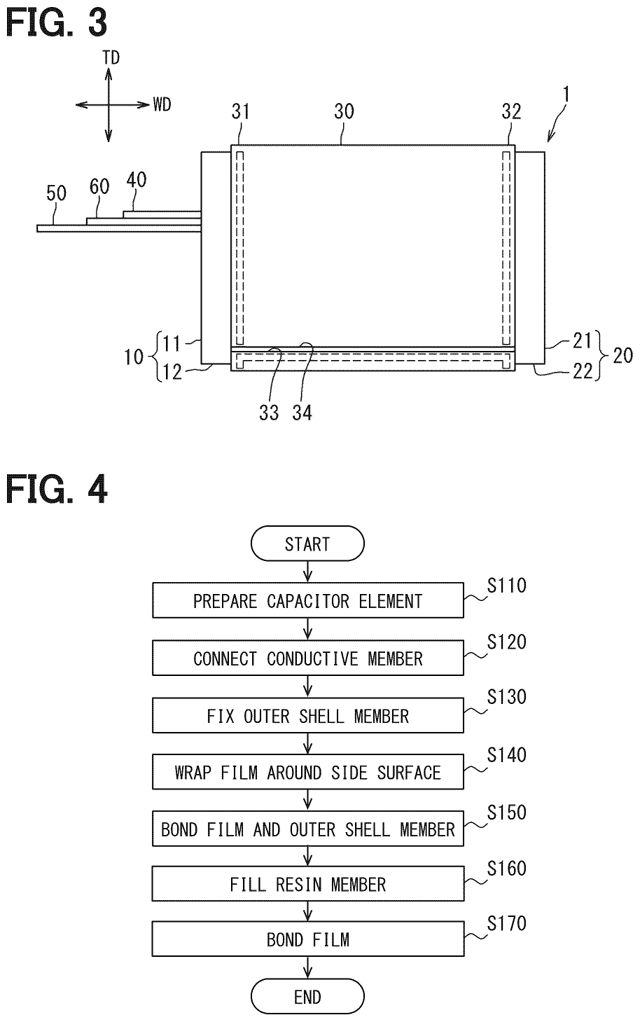

FIG. 3 is a side view of the capacitor 1. The first side portion 12 and the first film end 31 are bonded together. As an example, the first film end 31 and the first side portion 12 are heat welded together. The second side portion 22 and the second film end 32 are bonded together. As an example, the second film end portion and the second side portion 22 are heat welded together. The third film end 33 and the fourth film end 34 each have a region including a width in the longitudinal direction. The third film end 33 and the fourth film end 34 are butted against each other and overlap each other in a cross-like manner. The outer peripheries of the third film end 33 and the fourth film end 34 are heat welded together. The third film end 33 and the fourth film end 34 are sealed at the outer periphery. The overlapping portion of the third film end 33 and the fourth film end 34 is fixed to a portion of the film 30 disposed on the side surface 3 using an adhesive member. In the drawings, the dotted line area surrounded by a square corresponds to the heat-welded portion.

The method of bonding the film ends 31, 32 to the side portions 12, 22 is not limited to thermal welding. The method of bonding the third film end 33 and the fourth film end 34 is not limited to thermal welding. The film ends 31, 32 and the side portions 12, 22 may be bonded together using an adhesive member. The third film end 33 and the fourth film end 34 may be bonded together using an adhesive member. The first film end 31 and the second film end 32 may not be distinguished from each other and may be simply referred to as the film ends 31 and 32. The first side portion 12 and the second side portion 22 may not be distinguished from each other and may be simply referred to as the side portions 12 and 22.

The capacitor element 2 is fixed to the first outer shell member 10, the second outer shell member 20, and the film 30 by the resin member 70. Hereinafter, for ease of explanation, the first outer shell member 10, the second outer shell member 20, and the film 30 may be collectively referred to as exterior members 10, 20, and 30. The resin member 70 is disposed between the capacitor element 2 and the exterior members 10, 20, and 30. A space between the first outer shell member 10 and the capacitor element 2 is referred to as a first space 81. A space between the film 30 and the capacitor element 2 is referred to as a second space 82. A space between the second outer shell member 20 and the capacitor element 2 is referred to as a third space 83. The resin member 70 is provided across the first space 81, the second space 82, and the third space 83. Furthermore, the resin member 70 penetrates into the first exposure hole 13. The resin member 70 closes the first exposure hole 13. The first exposure hole 13 does not have to be blocked by the resin member 70. The resin member 70 does not necessarily have to be provided in the second space 82.

### <Method of Manufacturing a Capacitor>

FIG. 4 shows a flow chart for explaining a method for manufacturing the capacitor 1. First, in step S110, the capacitor element 2 is prepared. Next, in step S120, the conductive members 40, 50 are connected to the electrodes 5, 7. Specifically, the end of the first conductive member 40 is connected to the first electrode 5. The end of the second conductive member 50 is connected to the second electrode 7. The insulating member 60 is provided between the first conductive member 40 and the second conductive member 50. The insulating member 60 may be provided in advance on the first conductive member 40 or the second conductive member 50. In addition, the first electrode 5 and the second electrode 7 may not be distinguished from each other and may be simply referred to as the electrodes 5, 7.

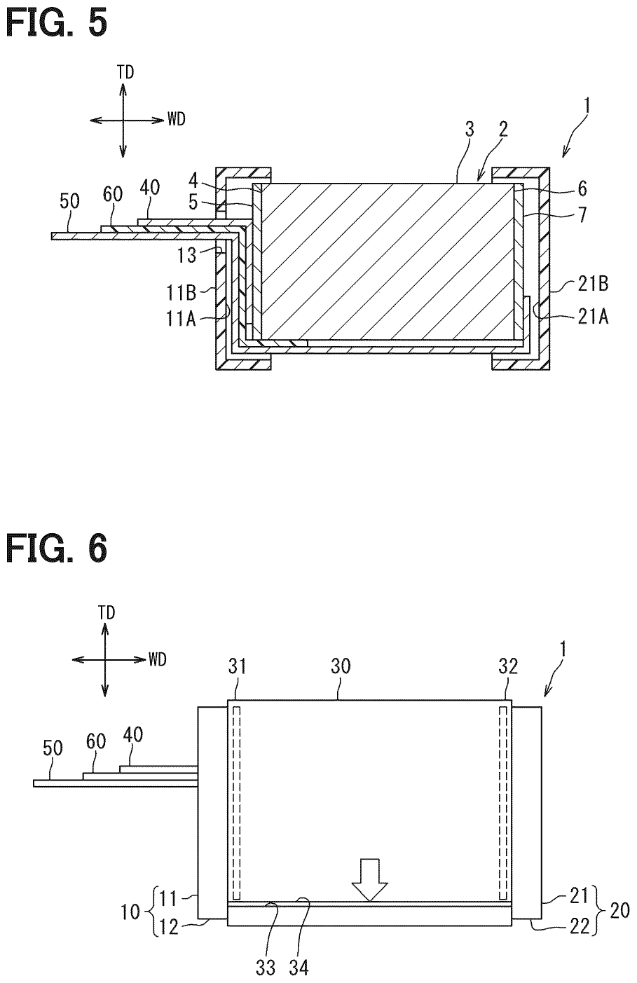

Next, in step S130, the outer shell members 10, 20 are provided on capacitor element 2. Specifically, the first outer shell member 10 is provided on the first end surface 4. The second outer shell member 20 is provided on the second end surface 6. The first outer shell member 10 is provided on the first end surface 4 while the first conductive member 40, the second conductive member 50, and the insulating member 60 are passed through the first exposure hole 13. FIG. 5 shows a method for fixing the outer shell members 10, 20 and the capacitor element 2 in step S130. The first outer shell member 10 is fitted onto the end portion on the first end surface 4 side like a cap. The second outer shell member 20 is fitted onto the end portion on the second end surface 6 side like a cap. In addition, the first outer shell member 10 may be fixed to a jig. The second outer shell member 20 may be fixed to a jig.

Next, in step S140, the film 30 is wrapped around the outer shell members 10, 20 from the outside. The film 30 is rolled along the side surface 3 with the first film end 31 overlapping the first side portion 12 and the second film end 32 overlapping the second side portion 22. At this time, the first side portion 12 and the second side portion 22 act as guides. The film 30 is wrapped around the outer shell members 10, 20 from the outside so that the third film end 33 and the fourth membrane end 34 overlap each other.

Next, in step S150, the film 30 and the outer shell members 10, 20 are bonded together. FIG. 6 shows a method for fastening the film 30 to the outer shell members 10, 20 in step S150. The first film end 31 and the first side portion 12 are bonded together by thermal welding. The second film end 32 and the second side portion 22 are bonded together by thermal welding. Next, in step S160, the resin member 70 is filled into spaces 81, 82, and 83 between the capacitor element 2 and the exterior members 10, 20, and 30. In step S150, the third film end 33 and the fourth film end 34 are not bonded to each other. In step S160, the resin member 70 is filled into the spaces 81, 82, and 83 from a position indicated by a white arrow in FIG. 6. It is not necessary to provide the resin member 70 in the second space 82.

When the third film end 33 and the fourth film end 34 are moved away from each other, a gap is created between the third film end 33 and the fourth film end 34 into which the resin member 70 can be poured. In step S160, the resin member 70 is filled into the spaces 81, 82, and 83 through the gap and then cured. After being cured, in step S170, the third film end 33 and the fourth film end 34 are heat-welded along the outer periphery. When the final ends of the third film end 33 and the fourth film end 34 in the longitudinal direction are heat-welded, vacuum sealing is performed. This makes it possible to press the capacitor element 2 against the film 30. After the third film end 33 and the fourth film end 34 are thermally welded together, the third film end 33 and the fourth film end 34 are tilted toward the side surface 3 and fixed to the portion of the film 30 located on the side surface 3 using an adhesive member. The process of curing the resin member 70 may be performed after step S170.

In a case molded capacitor, the capacitor element is housed in a resin case. The capacitor element and the case are fixed to each other by filling the case with a filling resin. In a high humidity environment, the capacitor element may suffer from problems such as a decrease in capacitance. For this reason, in case molded capacitors, the capacitor element is covered with a case and a filling resin to prevent moisture from penetrating into the capacitor element. In particular, in a configuration in which the case has an opening and a portion of the filling resin is exposed to the outside, the filling resin facing the opening comes into contact with the outside air. Therefore, measures are taken to increase the thickness of the filling resin facing the opening so as to prevent moisture from penetrating into the capacitor element. In this case, however, although the infiltration of moisture into the capacitor element can be suppressed, the overall weight of the capacitor increases.

### Operation and Effects

In the present embodiment, the capacitor 1 includes the capacitor element 2, the outer shell members 10, 20, and the film 30. The first outer shell member 10 is provided on the first end surface 4 of the capacitor element 2. The second outer shell member 20 is provided on the second end surface 6 of the capacitor element 2. The film 30 is provided on the outer periphery of the capacitor element 2 so as to extend along the side surface 3. The first film end 31 and the first side portion 12 overlap each other in a layered manner in the radial direction. The second film end 32 and the second side portion 22 overlap each other in a layered manner in the radial direction. According to this configuration, the end surfaces 4, 6 are covered with the outer shell members 10, 20, and the side surface 3 is covered with the film 30. Furthermore, the weight per unit area of the film 30 is lighter than the weight per unit area of the outer shell members 10, 20. Additionally, the film 30 and the outer shell members 10, 20 provide the necessary low moisture permeability. This allows the capacitor 1 to be lighter in weight and improves the performance of protecting the capacitor element 2 from moisture. By replacing the case in a case molded capacitor with the outer shell members 10, 20 and the film 30, it is possible to reduce the weight of capacitor 1 and improve the performance of protecting capacitor element 2 from moisture.

Furthermore, in the present embodiment, the outer shell members 10, 20 ensure sufficient mechanical strength to protect the capacitor element 2 from external mechanical forces. Therefore, the resin member 70 is not required to have high mechanical strength. Accordingly, the amount of the resin member 70 can be reduced. This allows the curing time to be shortened. Energy consumption by equipment involved in hardening can be reduced. It is also superior from the perspective of carbon neutrality.

The first film end 31 and the first side portion 12 are bonded together. The second film end 32 and the second side portion 22 are bonded together. This prevents a gap from being generated between the first film end 31 and the first side portion 12. The occurrence of a gap between the second film end 32 and the second side portion 22 is suppressed. The infiltration of moisture between the capacitor element 2 and the exterior member 80 through the gaps between the film ends 31, 32 and the side portions 12, 22 is suppressed.

The resin member 70 is provided in the first space 81 and the third space 83. Since the outer shell members 10 and 20 are overlapped with respect to the resin member 70 in multiple layers in the width direction WD, moisture can be efficiently prevented from penetrating into the capacitor element 2 from the width direction WD.

The resin member 70 is provided in the second space 82. Since the film 30 overlaps the resin member 70 in a layered manner in the radial direction, it is possible to efficiently prevent moisture from penetrating into the capacitor element 2 from the radial direction. Further, the resin member 70 is provided across the first space 81, the second space 82 and the third space 83. It is possible to efficiently prevent moisture from penetrating into the capacitor element 2 from the width direction WD and the radial direction. Furthermore, the film 30 is less permeable to moisture than the outer shell members 10, 20. Even if the thickness of the resin member 70 in the second space 82 is made thinner than the thickness of the resin member 70 in the first space 81 and the third space 83, the capacitor element 2 can be protected from moisture. Since the resin member 70 becomes thinner, the weight of the capacitor 1 can be reduced accordingly.

The first bottom portion 11 is provided with the first exposure hole 13 that opens to the first inner surface 11A and the first outer surface 11B. The first conductive member 40, the second conductive member 50 and the insulating member 60 are exposed from the first exposure hole 13. The first exposure hole 13 is closed by the resin member 70. This prevents moisture from penetrating between the capacitor element 2 and the exterior member 80 through the first exposure hole 13.

The insulating member 60 is provided between the first conductive member 40 and the second conductive member 50. The insulating member 60 is provided in the projected area of the first outer shell member 10. The parasitic inductance between the first conductive member 40 and the second conductive member 50 can be reduced with the minimum necessary amount of the insulating member 60.

### Second Embodiment

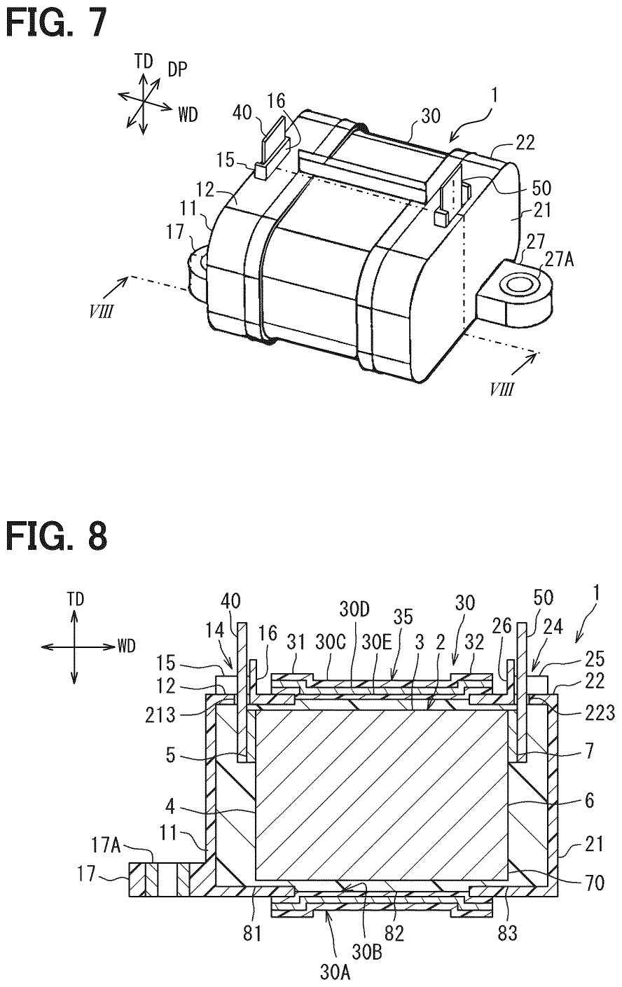

A capacitor 1 according to a second embodiment will now be described with reference to FIG. 7. FIG. 8 shows a cross section of the capacitor 1 in the direction of the arrow VIII in FIG. 7. In FIG. 8, the thickness of film 30 has been exaggerated somewhat to illustrate the multi-layer structure of film 30. The capacitor 1 in the second embodiment does not include the insulating member 60. A first exposure hole 213 is provided on the top side of the first side portion 12, penetrating from the inner surface to the outer surface. A second exposure hole 223 is provided on the top side of the second side portion 22, penetrating from the inner surface to the outer surface. The first conductive member 40 extends toward the first exposure hole 213. The tip of the first conductive member 40 is exposed from the first exposure hole 213. The first exposure hole 213 is closed by the resin member 70.

The second conductive member 50 extends toward the second exposure hole 223. The tip of the second conductive member 50 is exposed from the second exposure hole 223. The second exposure hole 223 is closed by the resin member 70. The first conductive member 40 and the second conductive member 50 are spaced apart from each other in the width direction WD. The first exposure hole 213 and the second exposure hole 223 may be closed by a sealing member 93 that is different from the resin member 70.

The first side portion 12 is provided with a first extension wall 14 extending along the edge of the first exposure hole 213. The first extension wall 14 is provided in a U-shape so as to fit along the edge of the first exposure hole 213. The first extension wall 14 includes two first side walls 15 and one first connecting wall 16. The two first side walls 15 extend from the first end surface 4 towards the second end surface 6. The first connecting wall 16 connects the two first side walls 15 along the edge of the first exposure hole 213 away from the first end surface 4 in the width direction WD. The first conductive member 40 exposed from the first exposure hole 213 and the first connecting wall 16 face each other in the width direction WD.

The second side portion 22 is provided with a second extension wall 24 extending along the edge of the second exposure hole 223. The second extension wall 24 is provided in a U-shape along the edge of the second exposure hole 223. The second extension wall 24 includes two second side walls 25 and one second connecting wall 26. The two second side walls 25 extend from the second end surface 6 toward the first end surface 4. The second connecting wall 26 connects the two second side walls 25 along the edge of the second exposure hole 223 away from the second end surface 6 in the width direction WD. The second conductive member 50 exposed from the second exposure hole 223 and the second connecting wall 26 face each other in the width direction WD.

The multi-layer structure constituting the film 30 is exposed from the end surface of the first film end 31. In the film 30, a second layer 30D which is a metal layer is disposed in a laminated manner between a first layer 30C which is a front surface resin layer and a third layer 30E which is a rear surface resin layer. A second layer 30D made of a metal member is exposed from the end surface of the first film end 31. A first connecting wall 16 is provided between the first conductive member 40 exposed from the first exposure hole 213 and the end surface of the first film end 31. The presence of the first connecting wall 16 increases the creepage distance between the first conductive member 40 and the first film end 31. This suppresses the formation of an unintended electrical path between the first conductive member 40 and the second layer 30D. An increase in the size of the capacitor 1 in the width direction WD is suppressed.

The multi-layer structure constituting the film 30 is exposed from the end surface of the second film end 32. The second layer 30D made of a metal member is exposed from the end surface of the second film end 32. A second connecting wall 26 is provided between the second conductive member 50 exposed from the second exposure hole 223 and the end surface of the second film end 32. The presence of the second connecting wall 26 increases the creepage distance between the second conductive member 50 and the second film end 32. This suppresses the formation of an unintended electrical path between the second conductive member 50 and the second layer 30D. An increase in the size of the capacitor 1 in the width direction WD is suppressed.

In addition to the first bottom portion 11 and the first side portion 12, the first outer shell member 10 has a first fastening portion 17 that is fastened to an external case or the like. The first fastening portion 17 is provided on the first bottom portion 11. The first fastening portion 17 extends in the width direction WD so as to move away from the first bottom portion 11. The first fastening portion 17 is provided with a through hole penetrating to the thickness direction TD. A metal bearing 17A through which the shaft of the bolt passes is provided in the through hole. The first outer shell member 10 is fixed by fixing the shaft of the bolt to an external case or the like. The bearing 17A and the first electrode 5 are separated from each other to an extent that they can be insulated from each other.

In addition to the second bottom portion 21 and the second side portion 22, the second outer shell member 20 has a second fastening portion 27 that is fastened to an external case or the like. The second fastening portion 27 is provided on the second bottom portion 21. The second fastening portion 27 extends in the width direction WD so as to move away from the second bottom portion 21. The second fastening portion 27 is provided with a through hole penetrating in the thickness direction TD. A metal bearing 27A through which the shaft of the bolt passes is provided in the through hole. The second outer shell member 20 is fixed by fixing the shaft of the bolt to an external case or the like. The bearing 27A and the second electrode 7 are separated from each other to an extent that they can be insulated from each other.

Furthermore, the first fastening portion 17 and the second fastening portion 27 are provided on diagonal corners of the capacitor 1 when viewed in a plan view in the thickness direction TD. The first fastening portions 17 and the second fastening portions 27 are arranged in a staggered manner in a plan view. By arranging the first fastening portion 17 and the second fastening portion 27 in this manner, the capacitor 1 is efficiently prevented from vibrating relative to an external case or the like.

The thickness of the film 30 is also constant. The film 30 is recessed towards the capacitor element 2 between the first outer shell member 10 and the second outer shell member 20. The film 30 is offset towards the capacitor element 2 between the first outer shell member 10 and the second outer shell member 20. The film 30 is recessed in a stepped shape towards the capacitor element 2 between the first outer shell member 10 and the second outer shell member 20. Hereinafter, for ease of explanation, the portion of the film 30 recessed toward the capacitor element 2 may be referred to as recess 35. The recess 35 is provided between the first film end 31 and the second film end 32. The recess 35 is fitted between the first side portion 12 and the second side portion 22. The space between the first side portion 12 and the second side portion 22 is closed by the recess 35.

The distance between the recess 35 and the capacitor element 2 in the radial direction is shorter than the distance between the film ends 31, 32 and the capacitor element 2 in the radial direction. The resin member 70 is filled into the first space 81, the second space 82, and the third space 83. The resin member 70 does not necessarily have to be provided in the second space 82. When the resin member 70 is filled into the first space 81 to the third space 83, the amount of resin member 70 filled between the recess 35 and the capacitor element 2 can be reduced compared to when the film 30 is not offset toward the capacitor element 2 at the center. Accordingly, the weight of the capacitor 1 is reduced.

### Third Embodiment

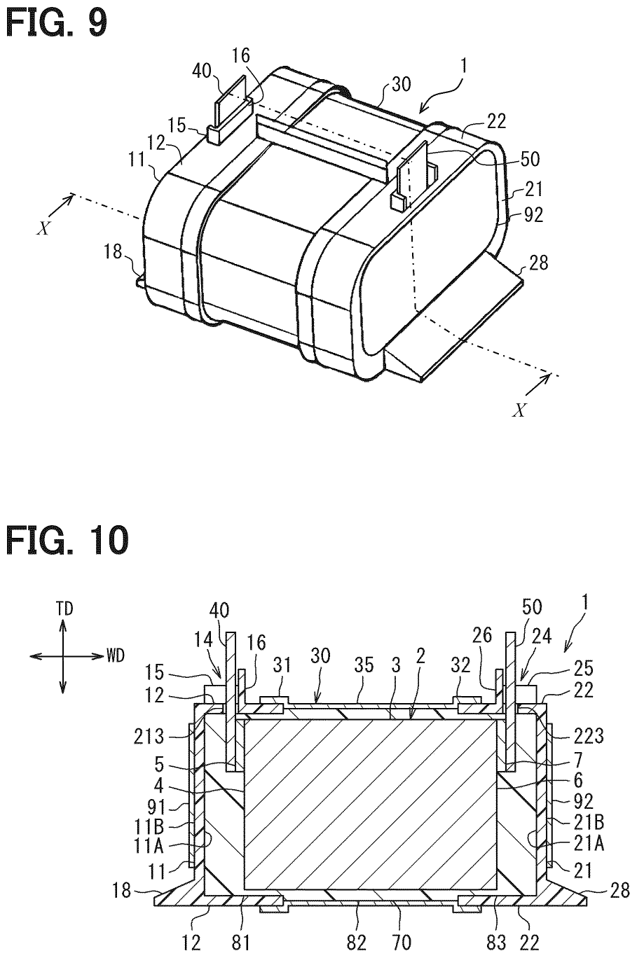

A capacitor 1 according to a third embodiment will be described with reference to FIG. 9. FIG. 10 shows a cross section of the capacitor 1 in the direction of an arrow X in FIG. 9. In the third embodiment, the capacitor 1 further includes a first covering member 91 and a second covering member 92. The first covering member 91 and the second covering member 92 are made of the same material as the film 30. The first covering member 91 and the second covering member 92 do not have to be made of the same material as the film 30. The first covering member 91 and the second covering member 92 may be made of any material having a lower moisture permeability than the outer shell members 10, 20.

The first covering member 91 is provided on the first outer surface 11B of the first bottom portion 11. The second covering member 92 is provided on the second outer surface 21B of the second bottom portion 21. According to this configuration, the first end surface 4, the resin member 70, the first bottom portion 11, and the first covering member 91 are overlapped in a layered manner in the width direction WD. The second end surface 6, the resin member 70, the first bottom portion 11, and the first covering member 91 are layered in the width direction WD. The moisture permeability of the covering members 91, 92 is lower than the moisture permeability of the outer shell members 10, 20. This effectively prevents moisture from penetrating into the capacitor element 2 from the width direction WD. Even if the amount of resin member 70 provided between bottoms 11, 21 and end surfaces 4, 6 is reduced, the performance of protecting the capacitor element 2 from moisture can be maintained. This makes it possible to achieve both weight reduction of the capacitor 1 and the performance of protecting the capacitor element 2 from moisture.

In the third embodiment, the first outer shell member 10 has a first engaging portion 18. The first engaging portion 18 extends away from the first bottom portion 11 in the width direction WD. The first engaging portion 18 has a narrower and pointed shape as it goes away from the first bottom portion 11. The second outer shell member 20 has a second engaging portion 28. The second engaging portion 28 extends away from the second bottom portion 21 in the width direction WD. The second engaging portion 28 has a narrower and pointed shape as it goes away from the second bottom portion 21. In cases where a plurality of capacitors 1 are provided and are resin-sealed in a large case, the first engaging portion 18 and the second engaging portion 28 provide an anchor effect for the sealing resin. The bonding area between the first outer shell member 10 and the sealing resin increases. The bonding area between the second outer shell member 20 and the sealing resin increases. This makes it possible to firmly fix the capacitor 1 to the sealing resin.

### Fourth Embodiment

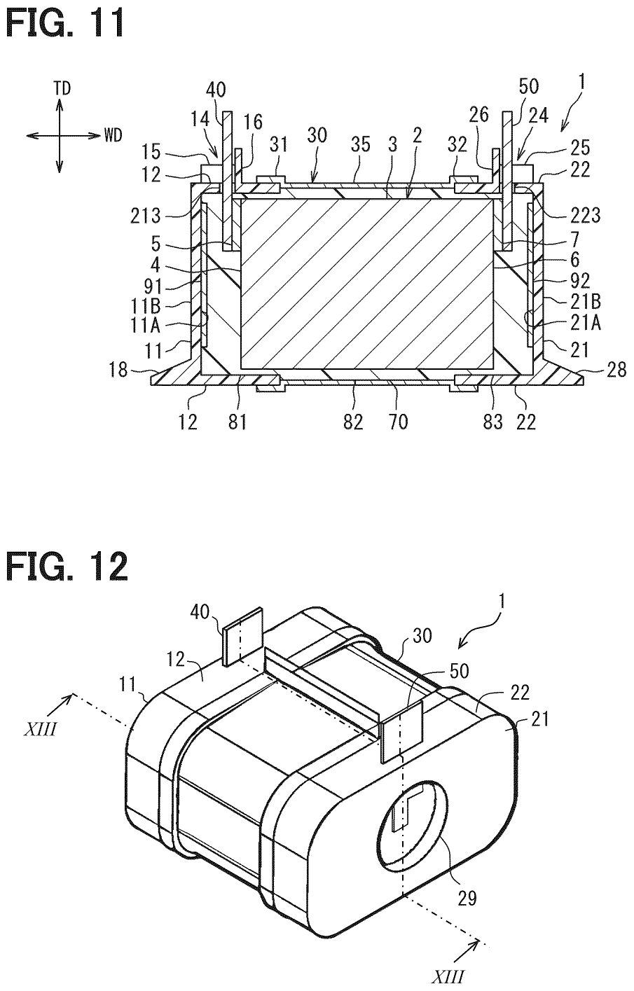

A capacitor 1 according to a fourth embodiment will be described with reference to FIG. 11. In the fourth embodiment, a first covering member 91 is provided on a first inner surface 11A of the first bottom portion 11. A second covering member 92 is provided on the second inner surface 21A of the second bottom portion 21. The fourth embodiment also obtains the same effects as the third embodiment. In addition, the first covering member 91 may be provided on the first inner surface 11A of the first bottom portion 11, and the second covering member 92 may be provided on the second outer surface 22B of the second bottom portion 21. The first covering member 91 may be provided on the first outer surface 11B of the first bottom portion 11, and the second covering member 92 may be provided on the second inner surface 21A of the second bottom portion 21. As such, the similar effects as described above can be achieved.

### Fifth Embodiment

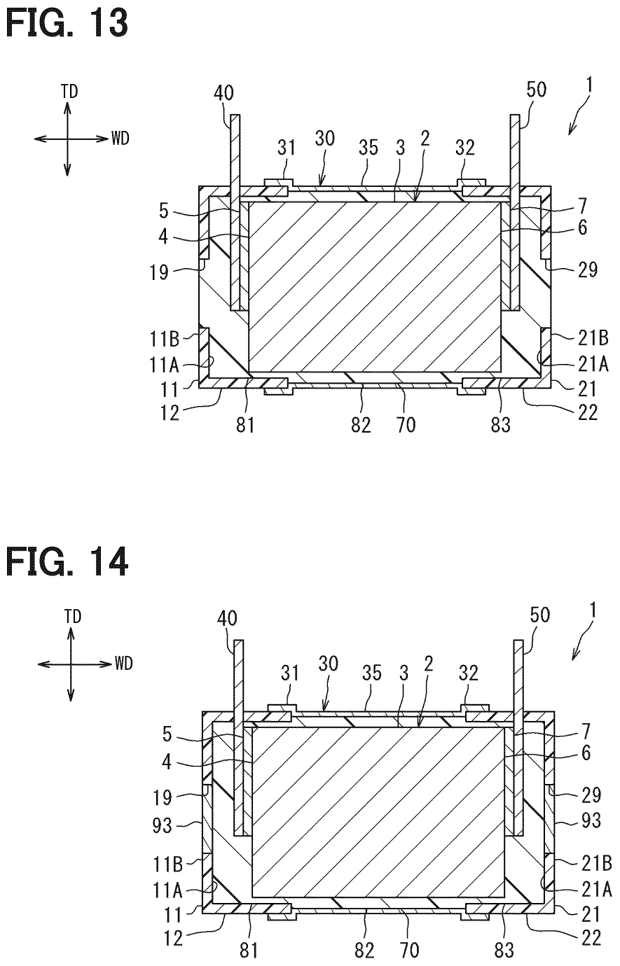

A capacitor 1 according to a second embodiment will be described with reference to FIG. 12. FIG. 13 shows a cross section of the capacitor 1 in the direction of the arrow XIII in FIG. 12. In the fifth embodiment, a first conductive member 40 is insert-molded into the first outer shell member 10. The first conductive member 40 is insert molded into the first side portion 12. The second conductive member 50 is insert molded into the second outer shell member 20. The second conductive member 50 is insert-molded into the second side portion 22.

The first bottom portion 11 is provided with a first opening 19 through which a welding arm can be inserted and removed between the first inner surface 11A and the first outer surface 11B. The second bottom portion 21 is provided with a second opening 29 through which the welding arm can be inserted and removed between the second inner surface 21A and the second outer surface 21B. The first electrode 5 and the first conductive member 40 are welded to each other at a position overlapping the first opening 19 in the width direction WD. The second electrode 7 and the second conductive member 50 are welded to each other at a position overlapping the second opening 29 in the width direction WD. Furthermore, the first opening 19 and the second opening 29 are closed by the resin member 70. Since the positional deviation of the conductive members 40, 50 is suppressed, the occurrence of poor connection between the conductive members 40, 50 and the electrodes 5, 7 is suppressed. The first opening 19 and the second opening 29 do not have to be closed by the resin member 70.

### Sixth Embodiment

A capacitor 1 according to a sixth embodiment will be described with reference to FIG. 14. In the sixth embodiment, a sealing member 93 separate from the resin member 70 may be provided in the first opening 19 and the second opening 29. The first opening 19 and the second opening 29 are closed by the sealing member 93. The first opening 19 may be closed by the resin member 70, and the second opening 29 may be closed by the sealing member 93. The first opening 19 may be closed by a sealing member 93, and the second opening 29 may be closed by a resin member 70.

### Seventh Embodiment

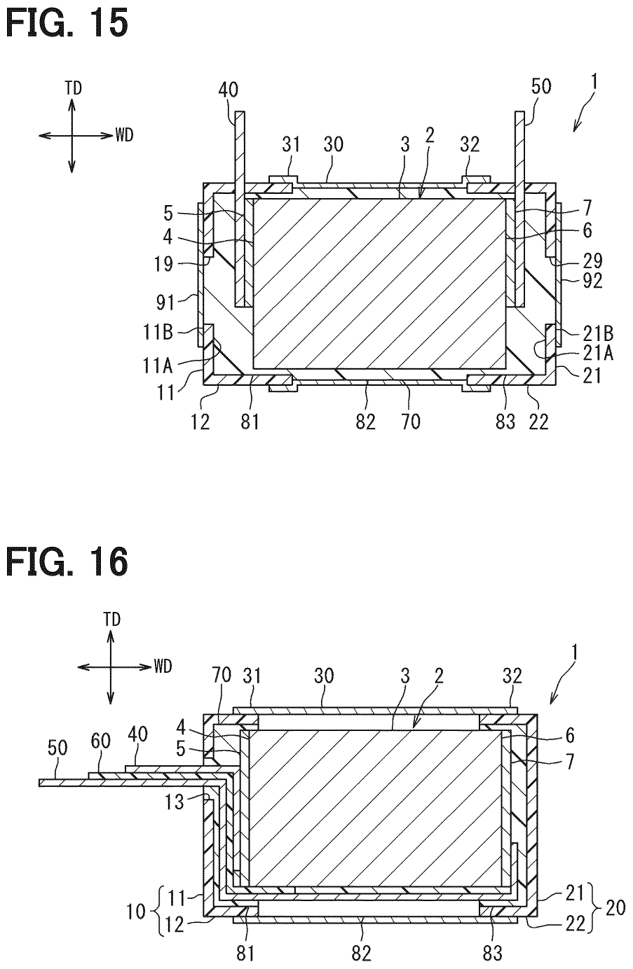

A capacitor 1 according to a seventh embodiment will be described with reference to FIG. 15. In the seventh embodiment, the capacitor 1 includes a first covering member 91 and a second covering member 92 made of the same material as the film 30. The first covering member 91 is large enough to cover the first opening 19. The second covering member 92 is large enough to cover the second opening 29. The covering members 91, 92 are provided on the bottom portions 11, 21 so as to close the openings 19, 29. As an example, the first covering member 91 is provided on a first outer surface 11B of the first bottom portion 11. The second covering member 92 is provided on the second outer surface 21B of the second bottom portion 21. This makes it easier to prevent moisture from coming into contact with the capacitor element 2. The covering members 91, 92 only need to be provided on the bottom portions 11, 21, and the surfaces on which they are provided may be either the outer surfaces 11B, 21B or the inner surfaces 11A, 21A. The covering members 91, 92 may be provided on both the outer surface 11B, 21B and the inner surface 11A, 21A.

### Eighth Embodiment

A capacitor 1 according to an eighth embodiment will be described with reference to FIG. 16. In the eighth embodiment, compared to the structure of the first embodiment, the resin member 70 is provided only in the first space 81 and the third space 83. The resin member 70 may not be provided in the first space 81, the second space 82, and the third space 83. It is not necessary for the resin member 70 to be provided in all of the first space 81, the second space 82, and the third space 83.

### Ninth Embodiment

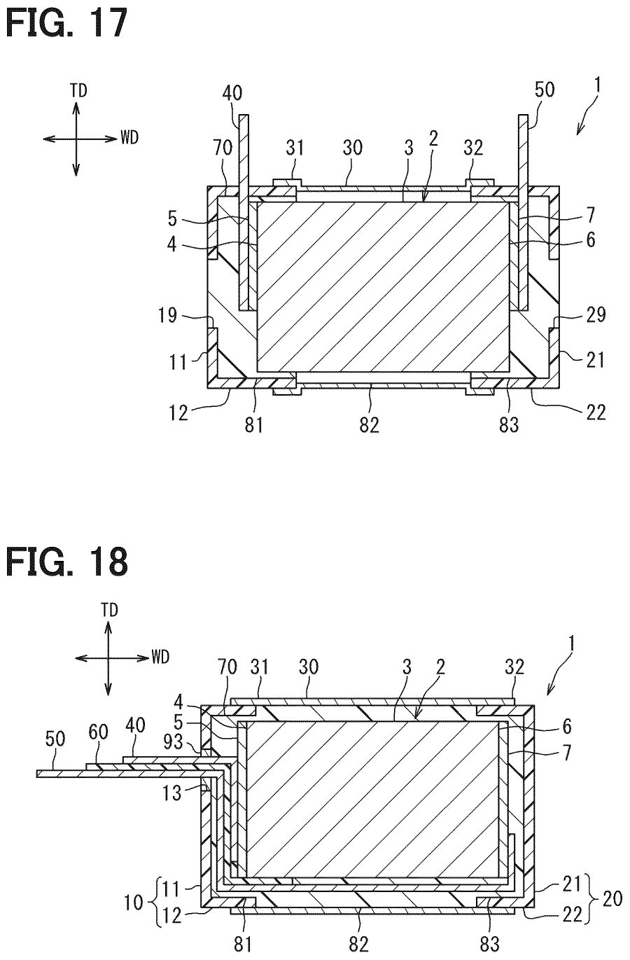

A capacitor 1 according to a ninth embodiment will be described with reference to FIG. 17. In the tenth embodiment, compared to the structure of the fifth embodiment, the resin member 70 is provided only in the first space 81 and the third space 83. In the capacitor 1 of the tenth embodiment, the resin member 70 does not necessarily have to be provided in all of the first space 81, the second space 82, and the third space 83.

### Tenth Embodiment

A capacitor 1 according to a tenth embodiment will be described with reference to FIG. 18. In the tenth embodiment, the first exposure hole 13 is closed by a sealing member 93 that is different from the resin member 70. This also makes it possible to prevent moisture from entering capacitor element 2.

### OTHER EMBODIMENTS

In the embodiment described so far, the capacitor element 2 is wrapped in a single continuous film 30. However, the film 30 is not limited to being single continuous film. Multiple films 30 may be used. The capacitor element 2 may be wrapped by a plurality of films 30. For example, it may be configured to have two films 30 and wrap the capacitor element 2 by thermally welding an end of one film to an end of another film. The number of films 30 is not limited. Alternatively, the film 30 may be constructed from a heat shrink film. In that case, the film 30 is also called a shrink label. The above-mentioned effects can be achieved even if the film 30 has a property of shrinking when heated.

What is claimed is:

1. A capacitor, comprising:
a capacitor element including a first end surface having a first electrode, a second end surface having a second electrode, and a side surface extending between the first end surface and the second end surface;
a first outer shell member provided on the first end surface and suppressing a permeation of moisture;
a second outer shell member provided on the second end surface and suppressing a permeation of moisture;
a film configured to overlap with the first outer shell member and the second outer shell member and cover the side surface, have a weight per unit area that is lighter than a weight per unit area of the first outer shell member and the second outer shell member, and suppress a permeation of moisture to the capacitor element works together with the first outer shell member and the second outer shell member;
a resin member disposed between the first and second outer shell members and the capacitor element, and between the film and the capacitor element;
a first conductive member provided on the first electrode; and
a second conductive member provided on the second electrode; wherein
the first outer shell member has a first opening that overlaps with a position where the first electrode and the first conductive member are welded,
the second outer shell member has a second opening that overlaps with a position where the second electrode and the second conductive member are welded, and
the first opening and the second opening are sealed by the resin member or a sealing member separate from the resin member.

2. The capacitor according to claim 1, wherein
bonded portions are provided at portions of the first outer shell member and the second outer shell member that overlap the film and at portions of the film that overlap the first outer shell member and the second outer shell member.

3. The capacitor according to claim 1, wherein
the film includes a recess between the first and second outer shell members that is recessed toward the capacitor element.

4. The capacitor according to claim 1, further comprising;
a covering member provided on inner surfaces of the first outer shell member and the second outer shell member or outer surfaces of the first outer shell member and the second outer shell member so as to suppress a moisture transmission through the first end surface and the second end surface together with the first outer shell member and the second outer shell member.

5. The capacitor according to claim 1, wherein
the first conductive member is insert-molded into the first outer shell member, and
the second conductive member is insert-molded into the second outer shell member.
